(19) United States
(12) Patent Application Publication
(10) Pub. No.: US 2002/0007772 A1
(43) Pub. Date: Jan. 24, 2002

(54) Method and installation for recovering energy from biomass and waste

(75) Inventors: Fransiscus J.J.G. Janssen, Arnhem (NL); Antonius J.A. Konings, Oosterbeek (NL)

Correspondence Address: BANNER & WITCOFF, 1001 G STREET N W, SUITE 1100, WASHINGTON, DC, 20001, US

(73) Assignee: N. V. Kema

(21) Appl. No.: 09/740,007

(22) Filed: Dec. 20, 2000

Related U.S. Application Data
(63) Continuation-in-part of application No. 09/051,321, filed on Sep. 10, 1998, now abandoned.

(30) Foreign Application Priority Data
Oct. 8, 1996 (NL) PCT/NL96/00393
Oct. 13, 1995 (EP) 95202756.3

(51) Int. Cl. F23J 15/00; F23J 11/00; F23J 3/00; F23C 9/00; F23G 7/06; F23B 5/00; F02C 7/08; F02G 3/00; F02G 1/00

(52) U.S. Cl. 110/345; 110/211; 110/216; 60/39.5

(57) ABSTRACT

An installation for generating power, comprising a main combustion chamber for burning fossil fuels, having means for generating steam; at least one thermal pre-processing chamber for processing carbonaceous materials; and a guiding duct for guiding the flue gases of at least one thermal pre-processing chamber to the main combustion chamber. The airflow in the thermal pre-processing chamber is toroidal. The thermal pre-processing chamber comprises an annular series of blades, a device for generating an air flow through the series of blades, a burner located under the series of blades, a cone shaped element in the center of the series of blades. The guiding duct has particle removal means, which are arranged to remove particles down to a size wherein the particles do not disturb processes in the main combustion chamber.

This application is a continuation-in-part of application Ser. No. 09/051,321, filed Sept. 10, 1998, which application is incorporated-by-reference in its entirety.

### FIELD OF THE INVENTION

The present invention relates to an installation for generating power.

### BACKGROUND OF THE INVENTION

Installations for generating power are known such as described in WO-A81/01713. This prior art installation is fit for processing waste materials only. However, the efficiency of electrical power generation by such an installation is limited to approximately 25%. This is due to the low temperature and pressure of the steam which is produced as a result of the often corrosive nature of flue gases from waste and to the smaller scale of the installation when compared with fossil fuel fired power plants.

### SUMMARY OF THE INVENTION

The present invention relates to an installation for generating power, comprising: a main combustion chamber, being provided with means for generating steam; at least one thermal pre-processing chamber for burning carbonaceous materials such as, but not limited to wood; a guiding duct for guiding the flue gases of the at least one thermal pre-processing chamber to the main combustion chamber.

The purpose of the invention is to provide an installation and a method adapted for generating electrical power from biomass and waste with a high efficiency but where capital costs are limited. Therefore the invention provides an installation wherein the main combustion chamber is fit for burning fossil fuels. This allows the use of conventional power stations, to which an additional installation, including the thermal pre-processing chamber, may be added for the combustion, gasification, or pyrolysis of waste materials. Carbonaceous materials replace part of the fossil fuel and the electric power generated by the power station remains unchanged.

### BRIEF DESCRIPTION OF THE DRAWINGS

FIG. 1 depicts an installation for processing waste in accordance with the invention.

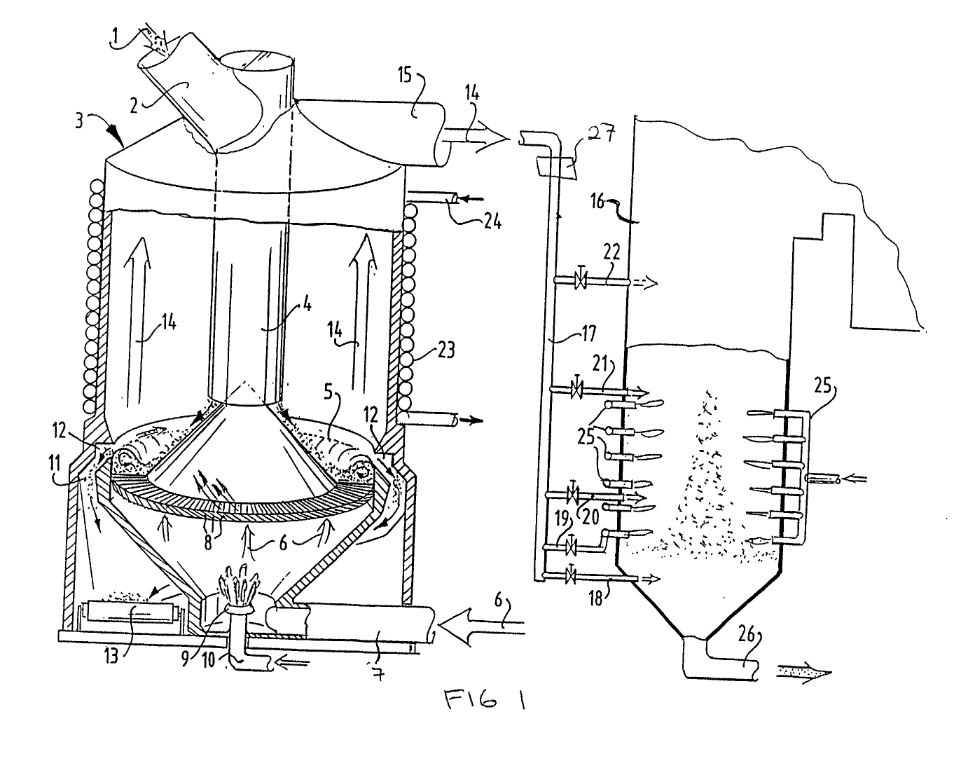

### DETAILED DESCRIPTION OF THE INVENTION

Trials have been made to burn waste materials in the main combustion chamber of a power station. Such combustion chambers are designed for firing of substantially pulverized solid fossil fuels; therefore, the waste materials must be pre-processed by cutting or milling them to the required size. This often requires a high amount of milling energy and excessive wear of the milling equipment making this not a very attractive option.

In a preferred embodiment of the invention, particle removal means, such as a cyclone, are provided in the guiding duct. The objective is to remove unburned carbon material that is too coarse to burn out completely in the subsequent combustion process in the main combustion chamber. The particle removal efficiency can be moderate, e.g. removal of particles bigger than 50 micron which can be achieved with a high gas rate type cyclone. Any other suitable particle remover means may be used such an electrostatic filter.

Preferably, the main combustion chamber is fit for burning pulverized coal. Also preferably, preheaters are incorporated in the duct for the flue gases of the main combustion chamber and/or the duct from the thermal pre-processing chamber for heating the combustion air for the main and thermal pre-processing chambers or for pre-heating feed water for steam generation.

Preferably the thermal pre-processing chamber is a so-called TORBED reactor. The TORBED reactor comprises an annular series of blades, a device for generating an air flow through the series of blades, a burner located under the series of blades, and a cone shaped element in the center of the series of blades. A thorough description of the TORBED reactor can be found in EP-A-0 068 853, EP-A-0 293 103, EP-A-0 288 141 and EP-A-0 286 273.

In different embodiments of the invention, the thermal pre-processing chamber may be used as a combustor, as a gasifier, or for pyrolysis.

When the thermal pre-processing chamber is used as a combustor, hot flue gas will enter the main chamber where the sensible heat will be used for steam generation and excess oxygen present in this flue gas will participate in the combustion process in the main combustion chamber.

When the thermal pre-processing chamber is used as a gasifier, hot fuel gas will enter the main chamber where the sensible heat will be used for steam generation and combustible gases such as carbon monoxide, hydrogen, and methane present in this fuel gas will participate in the combustion process in the main combustion chamber. This fuel gas, because of its reducing properties, also may be used as a reburning agent for reducing NOₓ-emissions from the main combustion chamber.

When the thermal pre-processing chamber is used as for pyrolysis, hot fuel gas will enter the main chamber where the sensible heat will be used for steam generation and combustible gases such as carbon monoxide, hydrogen and methane present in this fuel gas will participate in the combustion process in the main combustion chamber. The char fraction formed in the pyrolysis process can be mixed with the solid fossil fuel and milled together and thus participate in the combustion process in the main combustion chamber.

The installation of the invention is suited for a multitude of biomass and waste types. Preferably, carbonaceous wastes are used, such as wood, timber, wood from demolition activities, all kind of biomass especially grown for energy production (energy crops), chemical waste, municipal waste, refuse derived fuel (RDF), vegetable, fruit and garden waste and the like. Even polymeric materials, like PVC, may be burned. Furthermore, the invention may be used for fuel types that are difficult to process in the main combustion chamber such as petroleum cokes and the like.

If material such as demolition wood is used for co-combustion in the main combustion chamber, it must be reduced in size down to 1 millimeter prior to introduction in the main combustion chamber. However, according to the invention the waste material can be coarsely crushed down to approximately 10 centimeter before being processed in the TORBED. This is a very important advantage of the method of the invention since the pre-processing costs thereof are therefor much lower.

The principles of the present invention may find application in various practical embodiments that fall within the scope of this invention, but are not extensively described here since the skilled person will be capable of designing installations suited for a particular purpose based on the information given in this application. The invention will therefore be illustrated with reference to one embodiment only, schematically shown in the Figure.

In this embodiment waste material 1 is fed via a conduit 2 to a TORBED 3. The TORBED 3 comprises means 4 for supplying the waste to the toroidal bed 5. The bed 5 is produced by means of an air flow 6 that is supplied through a supply pipe 7. The air flow is channeled through a series of blades 8 thus causing the toroidal motion of the bed 5. The TORBED also comprises a burner 9 fed by means of a fuel pipe 10. The ashes 11 are discarded through an opening 12 along the periphery of the bed and collected in a container 13. As an alternative the ashes may be fed to the main combustion chamber together with flue gas.

The flue gas produced (symbolized by arrows 14) is discharged through a pipe 15 in the top of the TORBED 3. The flue gas 14 is transported to the main combustion chamber 16 via a duct 17, optionally first passing through a particle removal means 27 such as a cyclone or electrostatic filter. Depending on the operating mode (combustion, gasification, or pyrolysis) used for the thermal pre-processing process, the flue gas is discharged through one or more of the outlets 18, 19, 20, 21 and 22.

The use of a surplus of air will result in flue gas type A, comprising N₂, CO₂, H₂O, O₂, dust and other compounds. Use of a low amount of oxygen results in flue gas type B, having reducing properties and comprising CO, H₂, H₂O, O₂, CO₂ and dust.

Outlet 18 may be used for flue gas types A and B. Type A may also be injected via outlet 19 or together with the powder coal 25 introduced via inlet 20. Gases of type B may be introduced together with secondary air at outlet 20. Outlet 21 may be used for discharging flue gas type A together with so-called tertiary air. Reburn fuel (type B) may be introduced via outlet 22. The main combustion chamber has a series of burners 25, and an outlet for slag or bottom ash 26.

The heat produced in the combustion chamber may, for example, be used for the generation of steam for driving a turbine. Devices for generating steam in combustion chambers are well known to those skilled in the art and therefore not depicted here. The water from which the steam is produced may be pre-heated by the heat generated in the TORBED 3. For this purpose the TORBED7 is provided with a spiral pipe 23. Water 24 is transported through the spiral, pre-heated there and transported to the steam generating device (not shown).

We claim:

1. An installation for generating power comprising:
a main combustion chamber;
at least one thermal pre-processing chamber for burning carbonaceous materials;
a guiding duct for guiding the flue gases of said at least one thermal preprocessing chamber to the main combustion chamber, wherein the main combustion chamber burns fossil fuels.

2. The installation for generating power according to claim 1 wherein the installation is part of a power station.

3. The installation according to claim 1 wherein the guiding duct comprises particle removal means.

4. The installation according to claim 3 wherein the particle removal means removes particles down to a size that do not disturb processes in the main combustion chamber.

5. The installation according to claim 3 wherein the particle removal means comprises at least one cyclone.

6. The installation according to claim 3 wherein the particle removal means comprises at least one electrostatic filter.

7. The installation according to claim 1 wherein the fossil fuel comprises main pulverized coal.

8. The installation according to claim 1 wherein air preheaters are provided for heating combustion air for the main combustion chamber and the thermal pre-processing chamber.

9. The installation according to claim 1 wherein the main combustion chamber extends substantially vertically, and injection means are provided for injecting the flue gases of the thermal pre-processing chamber into the main combustion chamber wherein the injection means are substantially located in the part of the main combustion chamber wherein the combustion takes place.

10. The installation according to claim 1 wherein the main combustion chamber extends substantially vertically, and injection means are provided for injecting the flue gases of the thermal pre-processing chamber into the main combustion chamber wherein the injection means are substantially located in the upper part of the main combustion chamber.

11. The installation according to claim 1 wherein the thermal pre-processing chamber is a toroidal combustion chamber.

12. The installation of claim 1 wherein the main combustion chamber comprises means for generating steam.

13. A method for burning carbonaceous materials or fossil fuels comprising burning the carbonaceous materials or fossil fuels in an installation comprising:
burning carbonaceous materials in at least one thermal pre-processing chamber to form flue gases; guiding the flue gases through a guiding duct to a main combustion chamber having means for generating steam; and burning fossil fuels in the main combustion chamber.

14. The method according to claim 13 further comprising removing particles from the flue gases by particle removal means provided in the guiding duct.

15. The method according to claim 14 further comprising removing particles down to a size that do not disturb the processes in the main combustion chamber.

16. The method according to claim 14 further comprising removing particles with particle removal means having at least one cyclone.

17. The method according to claim 14 further comprising removing particles with particle removal means having at least an electrostatic filter.

18. The method according to claim 13 further comprising preheating combustion air with air preheaters prior to introducing the combustion air into the main combustion chamber, the thermal pre-processing chamber, or both.

19. The method according to claim 13 further comprising injecting the flue gases from the thermal pre-processing chamber into the main combustion chamber in the part of the main combustion chamber where the combustion takes place.

20. The method according to claim 13 further comprising injecting the flue gases from the thermal pre-processing chamber into the main combustion in the upper part of the main combustion chamber.
